(19) United States
(12) Patent Application Publication
(10) Pub. No.: US 2017/0175973 A1
(43) Pub. Date: Jun. 22, 2017

(54) LIGHTING DEVICE

(71) Applicant: HON HAI PRECISION INDUSTRY CO., LTD., New Taipei (TW)

(72) Inventors: FENG-YUEN DAI, Tu-Cheng (TW); CHAU-JIN HU, Tu-Cheng (TW); PO-CHOU CHEN, Tu-Cheng (TW)

(21) Appl. No.: 14/983,393

(22) Filed: Dec. 29, 2015

(30) Foreign Application Priority Data
Dec. 22, 2015 (CN) 201510966142.8

(51) Int. Cl. F21V 3/04; F21V 9/16

(52) U.S. Cl. CPC F21V 3/049; F21V 9/16; F21Y 2115/00

(57) ABSTRACT

A lighting device includes a substrate, a light source arranged on the substrate, and an optical cover arranged on the substrate. The optical cover includes an outside cover layer, an inside cover layer, and a quantum dots layer hermetically sandwiched between the outside cover layer and the inside cover layer. The optical cover and the substrate cooperatively define a enclosure space. The light source is located in the enclosure space. The inside cover layer is adjacent to the light source. In the enclosure space, a heat insulating gap is defined between the light source and the inside cover layer.

### FIELD

The subject matter herein generally relates to a lighting device.

### BACKGROUND

A quantum dot is a semi conductor nanocrystal with a diameter about 10 nm (nanometer) or smaller. The quantum dots emit light via stimulated electrons migration from a conduction band to a valence band. The quantum dots are capable of producing a quantum confinement effect. The quantum dots can emit stronger light in a narrow wavelength band than phosphors do. Even when the quantum dots are made of same materials, the quantum dots can emit light with different wavelength according to different particle sizes of the quantum dots. A wavelength of the light emitted from the quantum dots is positively correlated with the size of the quantum dots. Therefore, to obtain light within expected wavelength band is feasible via adjusting the particle size of the quantum dots.

### BRIEF DESCRIPTION OF THE DRAWINGS

Implementations of the present technology will now be described, by way of example only, with reference to the attached figures.

FIG. 1 is an isometric view of a first example embodiment of a lighting device.

FIG. 2 is an exploded, isometric view of the lighting device of FIG. 1.

FIG. 3 is a cross sectional view of the lighting device of FIG. 1.

FIG. 4 is a cross sectional view of a second example embodiment of a lighting device.

FIG. 5 is a cross sectional view of a third example embodiment of a lighting device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain sections have been exaggerated to better illustrate details and features of the present disclosure.

Several definitions that apply throughout this disclosure will now be presented.

The term “substantially” is defined to be essentially conforming to the dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a lighting device. The lighting device comprises a substrate, a light source arranged on the substrate, and an optical cover arranged on the substrate. The optical cover comprises an outside cover layer, an inside cover layer, and a quantum dots layer hermetically sandwiched between the outside cover layer and the inside cover layer. The optical cover and the substrate cooperatively define a enclosure space. The light source is located in the enclosure space. The inside cover layer is adjacent to the light source. In the enclosure space, a heat insulating gap is defined between the light source and the inside cover layer.

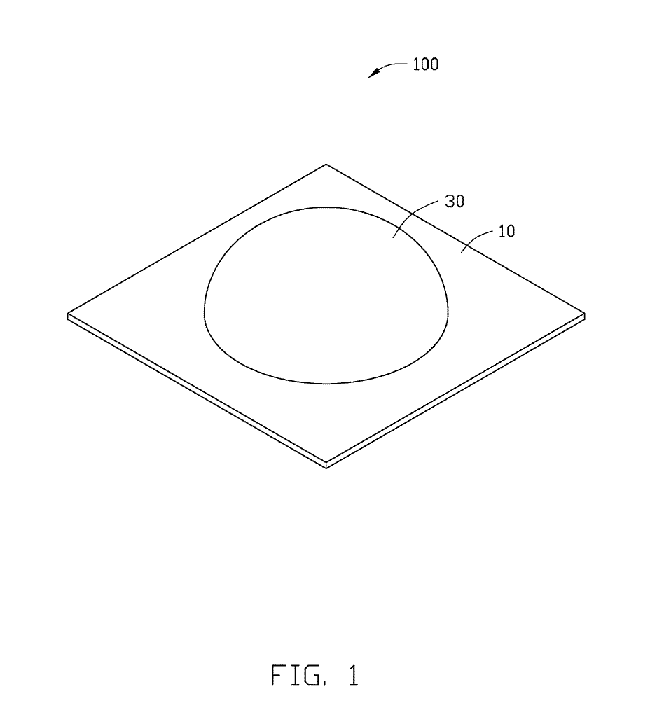

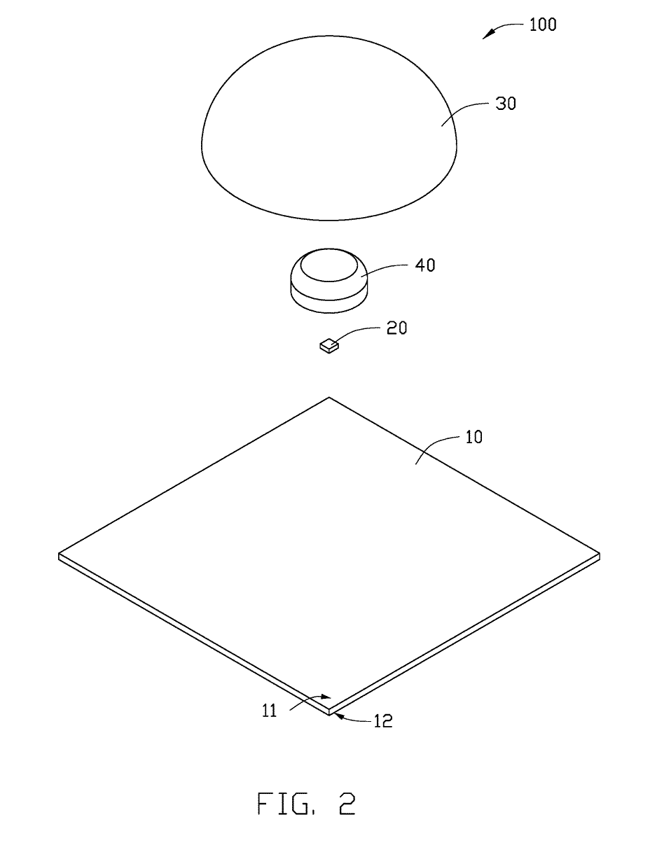

FIG. 1 and FIG. 2 illustrate a lighting device 100 of a first example embodiment. The lighting device 100 includes a substrate 10, a light source 20, an optical cover 30, and an optical lens 40.

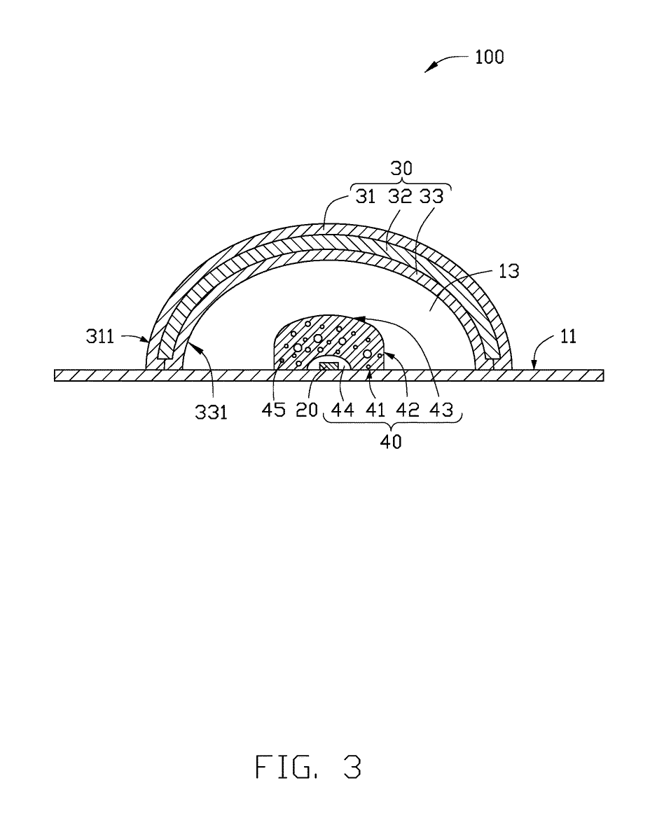

Referring to FIG. 3, the substrate 10 includes a first surface 11 and a second surface 12. The second surface 12 is opposite to the first surface 11. In at least one embodiment, the second surface 12 is parallel to the first surface 11. In at least one embodiment, the substrate 10 is a circuit board. The substrate 10 is configured to support the light source 20, the optical cover 30, and the optical lens 40, as well as to be a power supplement of the light source 20.

The light source 20 is arranged on and electrically connected with the substrate 10. In at least one embodiment, the light source 20 is arranged on the first surface 11. The light source 20 can be light emitting diode (LED) or laser diode (LD).

The optical cover 30 is arranged on the substrate 10. The optical cover 30 is substantially a hollow bowl shaped structure. The optical cover 30 and the substrate 10 cooperatively define an enclosure space 13. In at least one embodiment, the enclosure space 13 is substantially a vacuum. In at least one embodiment, the optical cover 30 is arranged on the first surface 11 and over the light source 20. In at least one embodiment, the light source 20 is located at a center of a portion of the first surface 11 corresponding to the enclosure space 13.

The optical cover 30 includes an outside cover layer 31, a quantum dots layer 32, and an inside cover layer 33. The quantum dots layer 32 is hermetically sandwiched between the outside cover layer 31 and the inside cover layer 33. The outside cover layer 31 and the inside cover layer 33 are configured to prevent the quantum dots layer 32 from service life shortens caused by being oxidized or being affected with damp.

The quantum dots layer 32 can be made of materials chosen from II-VI group compound semiconductor nanocrystals or III-V compound semiconductor nanocraystals, etc. The II-VI compound semiconductor nanocrystals can be Beryllium sulfide (BeS) , Selenium beryllium (BeSe), Beryllium beryllium (BeTe), magnesium selenide (MgSe), etc. The III-V group compound semiconductor nanocrystals can be aluminium nitride (AlN), aluminium phosphide (AlP), aluminium arsenide (AlAs), aluminum antimonide (AlSb), gallium nitride (GaN), gallium phoshpide (GaP), gallium arsenide (GaAs), etc.

The inside cover layer 33 is adjacent to the light source 20. In the enclosure space 13, a heat insulation gap is defined between the light source 20 and the inside cover layer 33. The heat insulation gap is configured to separate the optical cover 30 from generated heat of the light source 20, so as to prevent the quantum dots layer from service life shortens caused by being heated. The inside cover layer 33 includes an inner surface 331. The inner surface 331 is opposite to the quantum dots layer 32. In at least one embodiment, the inner surface 331 is substantially a smooth curved surface.

The outside cover layer 31 is opposite to the inside cover layer 33 and faces away from the light source 20. The outside cover layer 33 includes an outer surface 331. The outer surface 331 is opposite to the inner surface 311. In at least one embodiment, the outer surface 331 is substantially a smooth curved surface. The outside cover layer 31 and the inside cover layer 33 can be made of transparent materials, such as optical resin and glass.

The optical lens 40 is arranged on the substrate 10. The optical lens 40 is located in the enclosure space 13 and between the optical cover 30 and the light source 20. In one embodiment, the optical lens 40 includes a bottom surface 41, a side surface 42, and a top surface 43. In at least one embodiment, the bottom surface 41 is substantially a plane. The bottom surface 41 contacts the first surface 11. A recess 44 is defined via a depression from a center of the bottom surface into the optical lens 40. In one embodiment, the recess 44 is substantially semi ellipsoid. A long axis direction of the recess 44 is substantially parallel to the substrate 10. The light source 20 is received in the recess 44. In at least one embodiment, the light source 20 is located at a center of a portion of the first surface 11 corresponding to the recess 44. The side surface 42 is connected between the top surface 41 and the bottom surface 43. In one embodiment, the side surface 42 is substantially perpendicular to the bottom surface 41. The top surface 43 is opposite to the bottom surface 41. In one embodiment, the top surface 43 is a curved surface protruding away from the bottom surface 41. In at least one embodiment, a plurality of diffusing particles 45 is uniformly distributed in the optical lens 40. The diffusing particles 45 have different particle sizes.

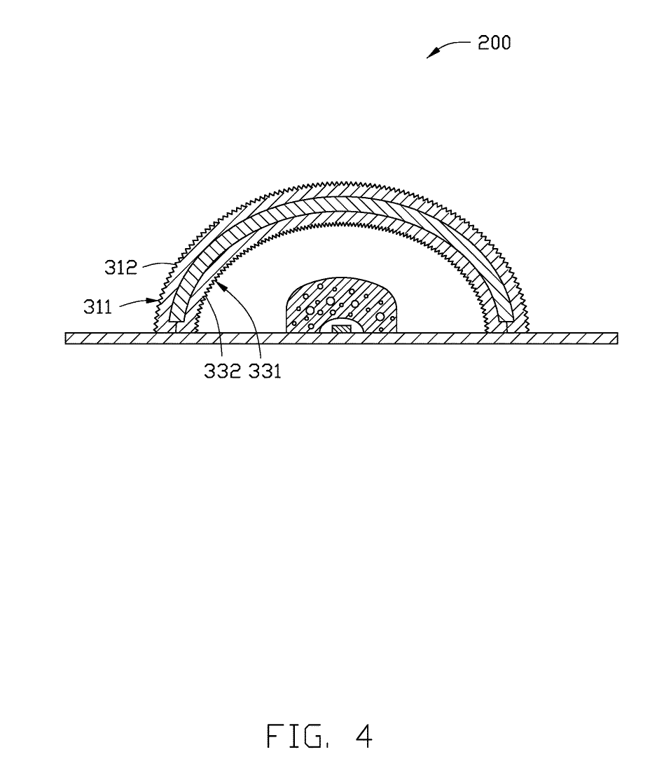

FIG. 4 illustrates a lighting device 200 of a second embodiment. The lighting device 200 is substantially similar to the lighting device 100. A difference between the lighting device 200 and the lighting device 100 is that a plurality of micro structures is formed on at least one of the inner surface 331 and the outer surface 311. In one embodiment, a plurality of inner micro structures 332 is formed on the inner surface 331. A plurality of outer micro structures 312 is formed on the outer surface 311.

The inner micro structures 332 and the outer micro structures 312 can be at least one of shapes, such as hemispherical, strip, cone. The inner micro structures 332 and the outer micro structures 312 are configured to make light emitted from the lighting device 200 evenly.

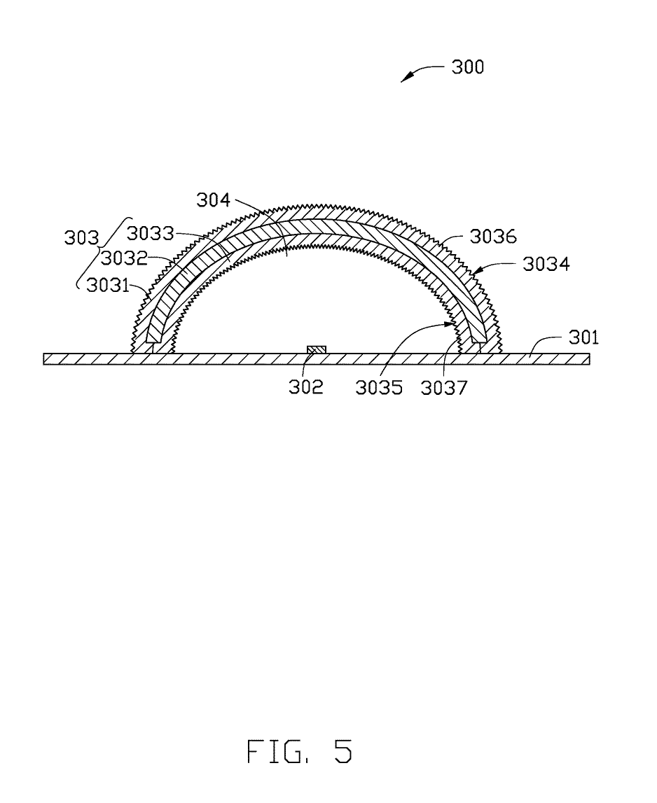

FIG. 5 illustrates a lighting 300 of a third embodiment. The lighting device 300 is substantially similar to the lighting device 200 and the lighting device 100. The lighting device 300 includes a substrate 301, a light source 302, and an optical cover 303. The light source 302 and the optical cover are arranged on the substrate 301. The optical cover 303 and the substrate 301 cooperatively define an enclosure space 304. The light source 302 is received in the enclosure space 304. The optical cover 303 includes an outside cover layer 3031, a quantum dots layer 3032, and an inside cover layer 3033. The quantum dots layer 3032 is hermetically sandwiched between the outside cover layer 3031 and the inside cover layer 3033. The outside cover layer 3031 includes an outer surface 3034. The inside cover layer 3033 includes an inner surface 3035. A plurality of outer micro structures 3036 is formed on the outer surface 3034. A plurality of inner micro structures 3037 is formed on the inner surface 3035. A difference between the lighting device 300 and the lighting devices 100 and 200 is that the optical lens 40 is omitted.

In other embodiment, a plurality of diffusing particles is uniformly distributed in at least one of the outside cover layer 31 and the inside cover layer 33.

In other embodiment, a plurality of micro structures is formed on at least one of the side surface 42 and the top surface 43.

In other embodiment, the heat insulation gap is filled with transparent heat insulating materials.

In other embodiment, the lighting device 100 further includes a heat insulating plate. The heat insulating plate is made of heat insulating resin. The heat insulating plate is located between the light source 20 and the substrate 10. The heat insulating plate is configured to dissipate heat generated by the light source 20.

The embodiments shown and described above are only examples. Many details are often found in the art such as the other features of a lighting device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the sections within the principles of the present disclosure, up to and including the full extent established by the broad general meaning of the terms used in the claims. It will therefore be appreciated that the embodiments described above may be modified within the scope of the claims.

What is claimed is:

1. A lighting device comprising:
a substrate;
a light source arranged on the substrate;
an optical cover arranged on the substrate, comprising an outside cover layer, an inside cover layer, and a quantum dots layer hermetically sandwiched between the outside cover layer and the inside cover layer,
wherein the optical cover and the substrate cooperatively define an enclosure space, the light source is located in the enclosure space, the inside cover layer is adjacent to the light source; and in the enclosure space, a heat insulating gap is defined between the light source and the inside cover layer.

2. The light device of claim 1, wherein the enclosure space is a vacuum.

3. The light device of claim 1, wherein the substrate comprises the light source is located at a center of a portion of the substrate corresponding to the enclosure space.

4. The light device of claim 1, wherein the outside cover layer comprises an outer surface facing away from the light source, and the inside cover layer comprises an inner surface adjacent to the light source.

5. The light device of claim 4, wherein a plurality of microstructures is formed on at least one of the outer surface and the inner surface.

6. The light device of claim 4, wherein the outer surface and the inner surface are both smooth curved surface.

7. The light device of claim 5, wherein the microstructures have at least one shape chosen from hemisphere, strip, and cone.

8. The light device of claim 1, further comprising an optical lens, wherein the optical lens is arranged on the substrate, and the optical lens is located in the enclosure space and between the light source and the optical cover.

9. The light device of claim 8, wherein the optical lens comprises a bottom surface, a top surface, and a side surface connected between the bottom surface and the top surface, the bottom surface is contacted with the substrate, a recess is defined at a center of the bottom surface, and the light source is located in the recess.

10. The light device of claim 9, wherein the recess is a semi ellipsoid, and a long axis direction of the recess is parallel to the substrate.

11. The light device of claim 9, wherein the light source is located at a center of a portion of the substrate corresponding to the recess.

12. The light device of claim 9, wherein a plurality of microstructures is formed on at least one of the side surface and the top surface.

13. The light device of claim 8, wherein a plurality of diffusing particles are distributed in the optical lens.

14. The light device of claim 13, wherein the diffusing particles have different particle sizes.
